(19) United States
(12) Patent Application Publication
(10) Pub. No.: US 2003/0128387 A1
(43) Pub. Date: Jul. 10, 2003

(54) Communication device

(76) Inventor: Tatsuo Noda, Nishinomiya-shi (JP)

Correspondence Address: JORDAN AND HAMBURG LLP, 122 EAST 42ND STREET, SUITE 4000, NEW YORK, NY, 10168, US

(21) Appl. No.: 10/305,454

(22) Filed: Nov. 27, 2002

(30) Foreign Application Priority Data
Nov. 30, 2001 (JP) 2001-365903(PAT.)

(51) Int. Cl. B41J 1/00; G06F 15/00; H04N 1/00

(52) U.S. Cl. 358/1.15; 358/402

(57) ABSTRACT

Communication device such as a network scanner and a network facsimile, for transmitting image data to one or more designated addressee from a designated addressor. To facilitate setting of addressees and addressor, ID data of addressees and addressors are registered in advance and the addressees and addressors are assigned to particular one touch keys. According to the present invention, user may not register the same ID data twice both as the addressee and as the addressor. To this end, a memory 23 stores the ID data of the addressees and addressors and a data selection control output from the memory data of addressees and addressors as candidates of addressees when a user set a addressee to whom the image data is to be sent. The memory may store the data of addressees and addressors separately or all together. The selection control may be arranged to output only the data including E-mail address when the communication device is set to send the image data through E-mail.

### BACKGROUND OF THE INVENTION

1. Field of the Invention

The present invention relates to a communication device, and especially pertains to a communication device such as a network scanner, network facsimile on which addressed of addressors and addressees are registered for transmission of data therethrough.

2. Description of the Related Art

Recently, a network system is provided in which an in-house LAN connects a plurality of terminal devices such as personal computers, a server, a printer, a facsimile machine, a scanner and the like with one another to enable common use of the printer, facsimile machine and scanner among the users.

The communication device in the network system such as the network scanner and the facsimile machines are used by a plurality of users so that it is necessary to set not only an addressee but also an addressor at the time of operation of the device. Many of such communication devices are generally provided with function of address registration wherein identification data (ID data) of addressors and addressees are registered in the device and the addressors and addressees are assigned to respective one touch keys such that the addresses and addressors are selected and set by means of the one touch keys. With this function, the user may register ID data such as names, IP addresses, electric mail address, and the like of the addressees and addressors which are often used, such that a desired addressor or addressee is designated by the operation of the one touch key upon sending data.

However, conventional communication devices are arranged such that the ID data of addressors and ID data of addressees are registered separately from each other and accessed separately. In more detail, the Id data registered for addressees are not displayed as candidates of addressor and user must take time to register the same ID data in both addressor memory region or area and addressee memory region or area of the communication device when an user or an addressor is expected to be both addressor and addressee.

For example, when image data taken by a commonly used network scanner are transmitted to a personal computer of the person at the desk next to the user, it is desirable to register the personal computer of the next desk person as an addressee and register the use's personal computer as an addressor. On the other hand, for the case when the next desk person uses the network scanner, it is desirable to register the computer of the next desk person as an addressor so that the person may designate his/her personal computer as an addressor. To this end, the conventional devices require double registration of the same ID data at addressor and addressee memory regions.

### SUMMARY OF THE INVENTION

Accordingly, an object of the invention is to provide a communication device which can be operated easily with less work.

Another object of the present invention is to provide a communication device which facilitates registering of and access to addressors and addressees.

A still another object of the present invention is to provide a communication device which provide common use of a single set of ID data for the setting of addressees and addressors.

A further object of the present invention is to provide a communication device with which a desired data can be accessed for either of addressees and addressors unless the same ID data are registered in both addressee and addressor memory areas.

Still further object of the present invention is to provide a communication device in which a desired ID data is easily accessed upon setting of addressees and addressors.

To attain one or more of the above mentioned objects, a communication device according to the present invention comprises a memory for storing registered data of addressors and addressees, and a selection control for selecting and outputting a required one of registered data, and the selection control outputs all the registered data stored in the memory when a candidate of an addressee is to be output or displayed.

With this arrangement, all the registered addressee and addressor data are displayed upon selection of an addressee for data transmission. Then, the user may not take trouble of registering twice the same data for an addressee and addressor, thereby reducing the time for registering.

According to an aspect of the present invention, the memory may include an addressor memory for storing registered data of addressors, and addressee memory for storing registered data of addressees, and the selection control output both the data stored at addressor memory and addressee memories as candidates of addressees.

According to this arrangement, addressors and addressees are registered separately upon registration, but both the data of addressors and addressees are output for the selection of an addressee so that it is unnecessary to register in addressee memory section, the data which have been registered again for the purpose of addressor selection, thereby reducing the time required for registration.

Further, the selection control of the communication device according to the present invention, may arranged to output only the data registered at addressor memory as candidates of addressor.

This arrangement benefits that only the data of addressor are output for the purpose of selection of an addressor without outputting data of addressees which is usually unnecessary for the selection of a addressor, thereby reducing the number of candidates from which the use can select a desired addressor easily.

According to still another aspect of the present invention, the communication device may be arranged such that, of the data registered at addressee memory and addressor memory, the selection control outputs only the data including electric mail (E-mail) address data when one or more addresses are to be selected for E-mail communication.

This arrangement facilitates the operation of the user who may select the address or addresses from the data from which the data without the E-mail address have been excluded.

According to yet further aspect of the present invention, the communication device may be arranged such that, of the data registered at addressee memory and addressor memory, the selection control outputs only the data including IP address data when one or more addresses are to be selected for communication designating IP address of a terminal device of an addressee.

This arrangement facilitates the operation of the user who may select the address or addresses from the data from which the data without the IP address have been excluded.

The communication device may be a network scanner, network facsimile or the like. It is to be noted that throughout the specification, the term addressor means a person or other entity identified as one sending data or information, while the term addressee means a person or other entity identified as one to receive the data or information.

The above and further objects and novel features of the invention will more fully appear from the following detailed description when the same is read in connection with the accompanying drawings. It is to be understood, however, that the drawings are for purpose of illustration only and are not intended as a definition of the limits of the invention.

### BRIEF DESCRIPTION OF THE DRAWINGS

FIG. 1 is a block diagram showing arrangement of a network system employing a network scanner according to an embodiment of the present invention;

FIG. 2 is a block diagram showing a main part of a network scanner according to an embodiment of the present invention, the main part being concerned with registration/selection of addressors and addressees;

FIG. 3 shows a screen for the user data registration/deletion on a network scanner according to an embodiment of the present invention;

FIG. 4 shows a screen for the registration of user data on a network scanner according to an embodiment of the present invention;

FIG. 5 shows a screen for the selection of scanner function of a network scanner according to an embodiment of the present invention;

FIG. 6 shows a screen of address book for the transmission of E-mail by means of a network scanner according to an embodiment of the present invention;

FIG. 7 shows a screen for the registration of new addressees for transmission of E-mail by means of a network scanner according to an embodiment of the present invention;

FIG. 8 shows a screen of address book for PC transmission of the data taken by a network scanner according to an embodiment of the present invention;

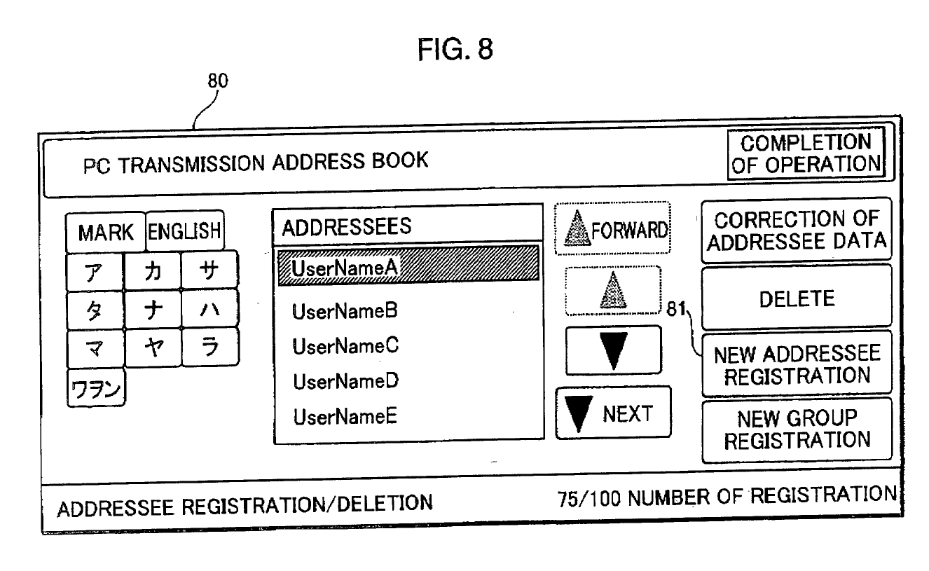

FIG. 9 shows a screen for the registration of new addressees for PC transmission of the data taken by a network scanner according to an embodiment of the present invention;

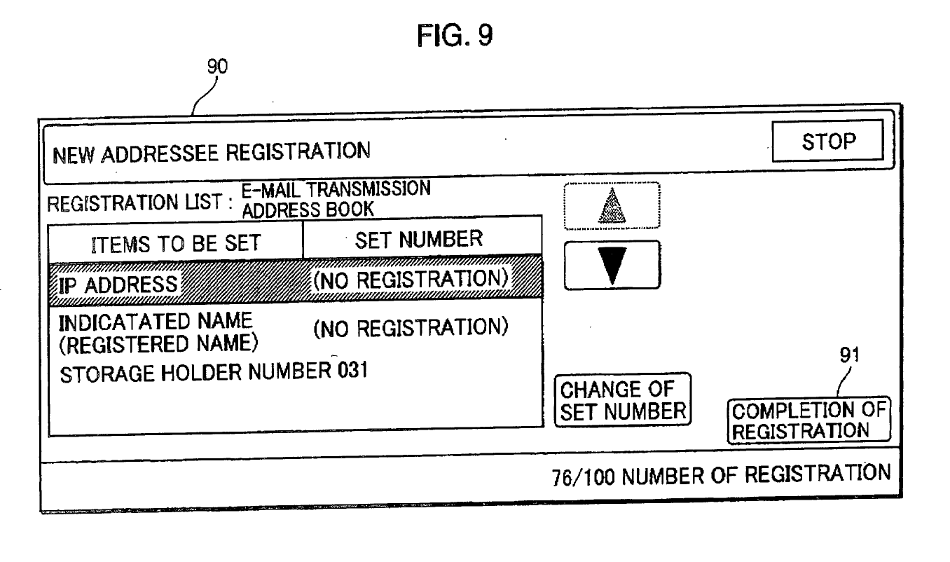

FIG. 10 shows a screen for the selection of an addressor (user sending data) on a network scanner according to an embodiment of the present invention;

FIG. 11 shows a screen for the selection of E-mail addressee on a network scanner according to an embodiment of the present invention;

FIG. 12 shows a screen for inputting E-mail addresses on a network scanner according to an embodiment of the present invention;

FIG. 13 shows a screen for the selection of addressee on a network scanner according to an embodiment of the present invention;

FIG. 14 shows a screen for the selection of PS transmission addressee on a network scanner according to an embodiment of the present invention; and

FIG. 15 shows a screen for the selection of addressee on a network scanner according to an embodiment of the present invention.

### DESCRIPTION OF THE PREFERRED EMBODIMENTS

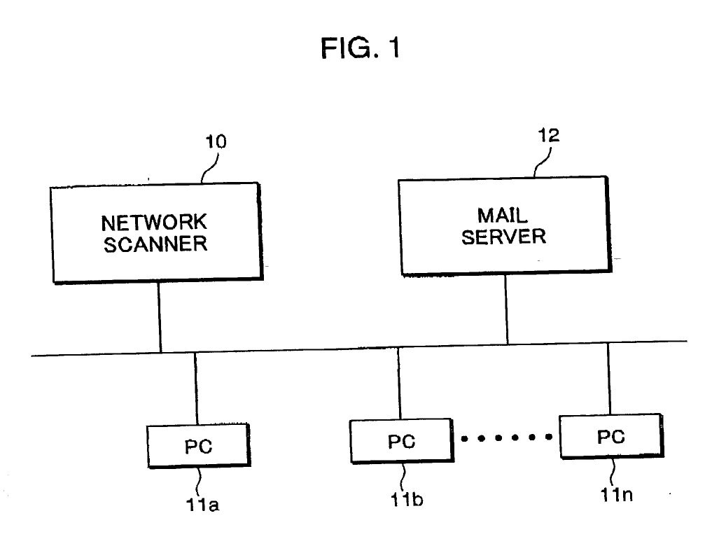

FIG. 1 is a block diagram showing the construction or arrangement of the network system including a network scanner as an embodiment of the present invention. The network system constructed by in-house or inter-company LAN (Local Area Network) or the like, includes a network scanner 10, personal computers 11a through 11n (n may be any number) and a mail server 12. The network scanner 10 functions as a communication device which send image data taken thereby, directly to terminal devices such as the personal computers 11a through 11n, and send the image data through E-mail. The personal computers 11a through 11n receive the image data from the network scanner 10 and send and receive E-mail messages. The mail server 12 stores and deliver E-mail message.

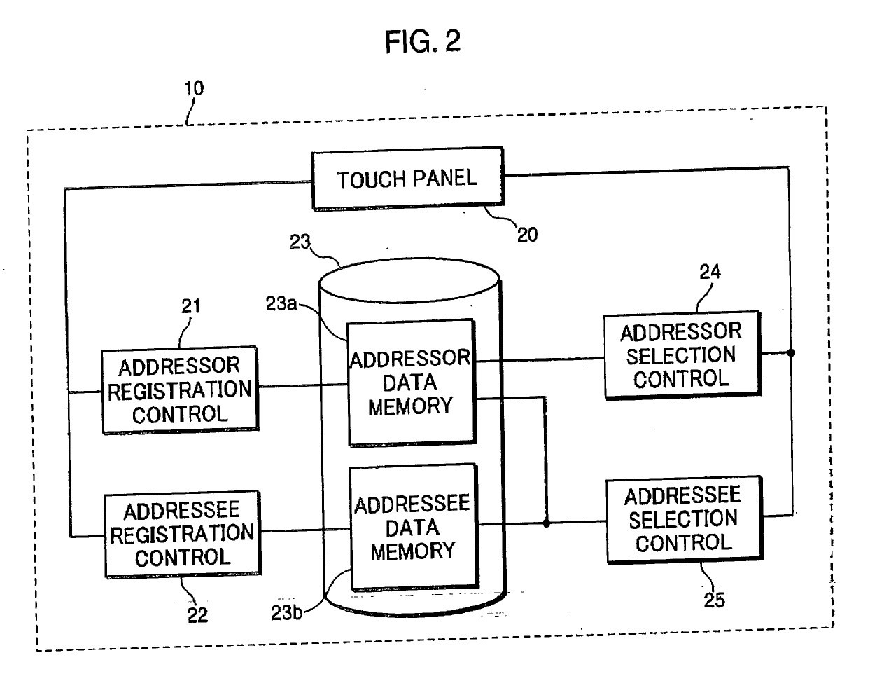

FIG. 2 is a block diagram showing the main part of the network scanner 10 that is concerned with registration/selection of addressors and addressees. Referring to FIG. 2, a touch panel 20 displays on its screen the data necessary for data input operation, and at the same time, data are input and set thereon when a user touch particular portion of the screen. The addressor registration control 21 controls registration of addressor data in response to input operation by means of the touch panel 20. The addressee registration control 22 controls registration of addressee data in response to input operation by means of the touch panel 20. The memory 23 includes a hard disk drive (HDD) and the like to store registered data received from the addressor registration control 21 and the addressee registration control 22. An addressor selection control 24 selectively read the required data from the memory 23 and send the data to the touch panel 20 for the display of candidates of addressors on the touch panel 20. An addressee selection control 25 selectively read the required data from the memory 23 and send the data to the touch panel 20 for the display of candidates of addressees on the touch panel 20.

The memory 23 is composed of a addressor data memory 23a for storing registered data of addressors and addressee data memory 23b for storing registered data of addressees It is apparent to those skilled in the art that any one of the personal computers 11a thorough 11n may be use in place of the touch panel 20, as the interface for inputting and selecting addressor and addressee data.

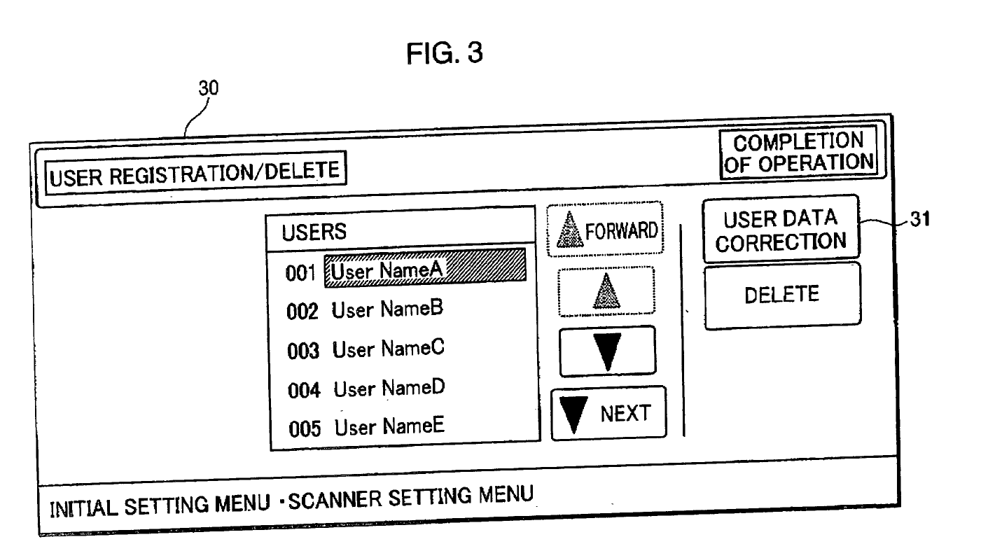

Next, explanation will be made about the operation of the network scanner for the registration of addressors and addressees. When an addressor is registered, the user may operate the touch panel 20 to select user registration/deletion and scanner setting menu on the screen of initial setting menu (not shown but as is well-known in the art). Then, a screen 30 for user registration/deletion as shown in FIG. 3 is displayed. The user may determine which of the addresses indicated by the numbers of users (addressors) on the user registration/deletion screen is to be used for the registration of user ID data.

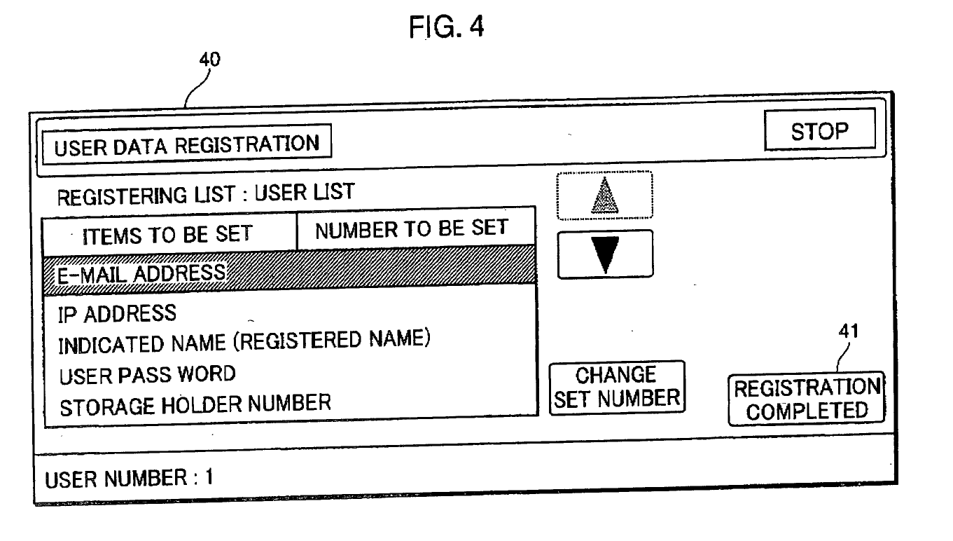

For example, if the user selects “001 USER NAME A” by touching the portion of that indication, and also select USER DATA CORRECTION by touching the portion of that indication, then a user data registration screen 40 as shown in FIG. 4 is displayed. As is apparent to those skilled in the art, the operation of the touch panel is made by touching a particularly indicated portion to select that indicated data or setting. Accordingly, reference to the touching to the touch panel is not described heretofore, but touching operation is actually made.

With the user data registration screen 40, the use may input user's E-mail address, IP address (name to be registered), pass word and storage holder number, and then operates registration completed to complete the registration of the addressor. At this time, the registered data are stored at the addressor memory 23a by way of addressor registration control 21.

On the other hand, when a addressee is registered, an ADDRESS BOOK EDITION 51 is selected on the scanner selection screen 50 shown in FIG. 51, and the user may select either E-MAIL TRANSMISSION or PC TRANSMISSION.

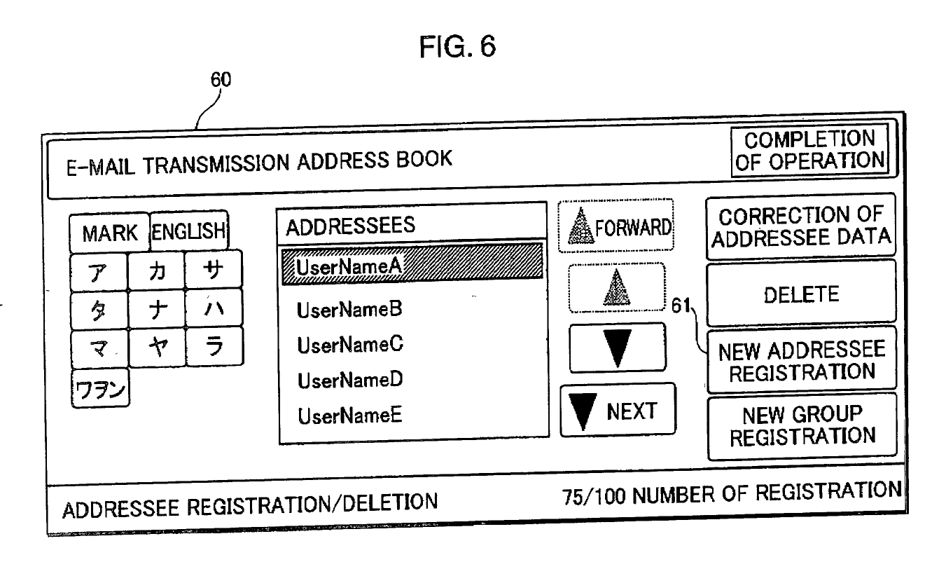

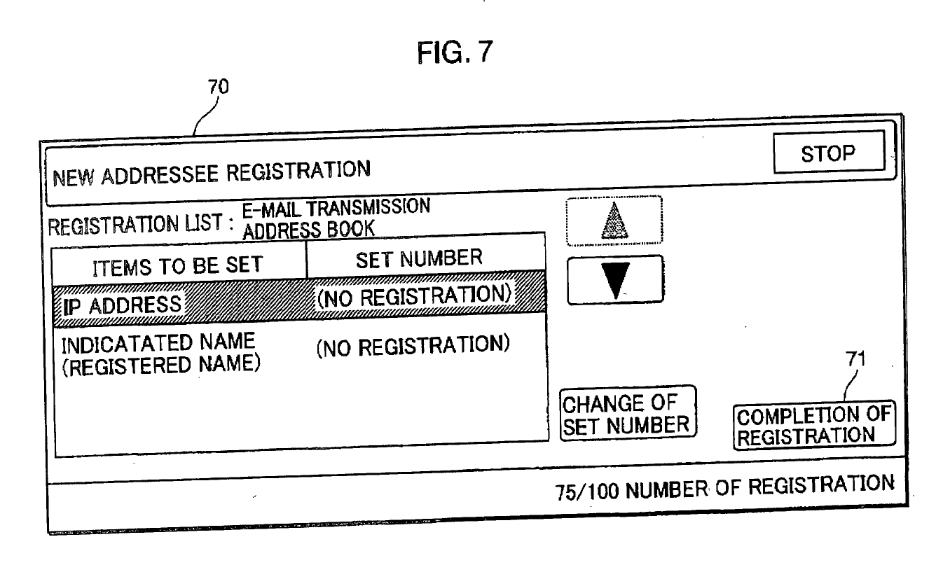

When E-MAIL TRANSMISSION is selected, a screen 60 for E-mail transmission address book as shown in FIG. 6 is displayed. If NEW ADDRESSEE REGISTRATION 61 is selected on the E-mail transmission address book screen 60, a new addressee registration screen 70 as shown in FIG. 7 is displayed. With the new addressee registration screen 70, the user may input an E-mail address, an indicated or identification name and other required data, and finally operate COMPLETION OF REGISTRATION 71 to complete the registration of an E-mail addressee. At this time, the registered data are stored at the addressee memory 23b as an E-mail transmission address book, by way of addressee registration control 22.

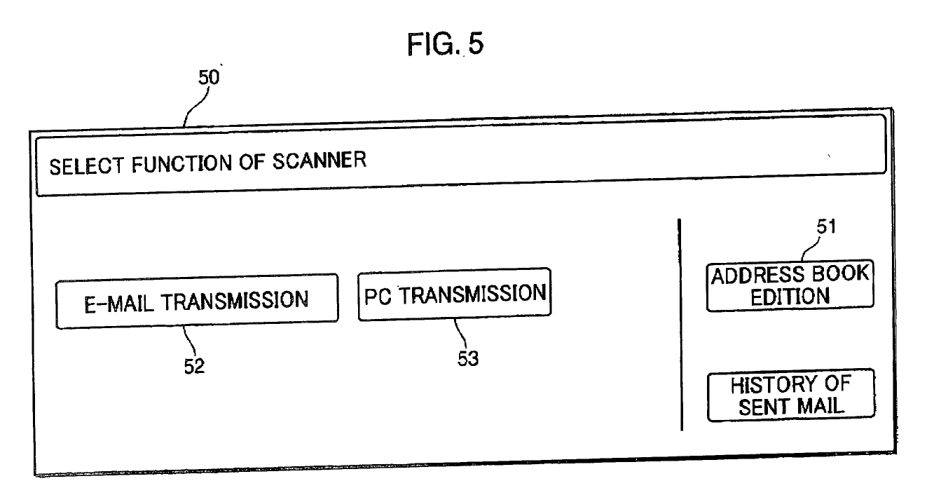

Next, explanation will be made about the operation of the network scanner 10 at the time when an addressor or addressee is selected for sending image data. The network scanner 10 may send or transmit image data by means of E-mail transmission and PC transmission. Upon sending image data, the use may select either of E-MAIL TRANSMISSION 52 and PC TRANSMISSION 53 on the scanner function selecting screen 50 shown in FIG. 5.

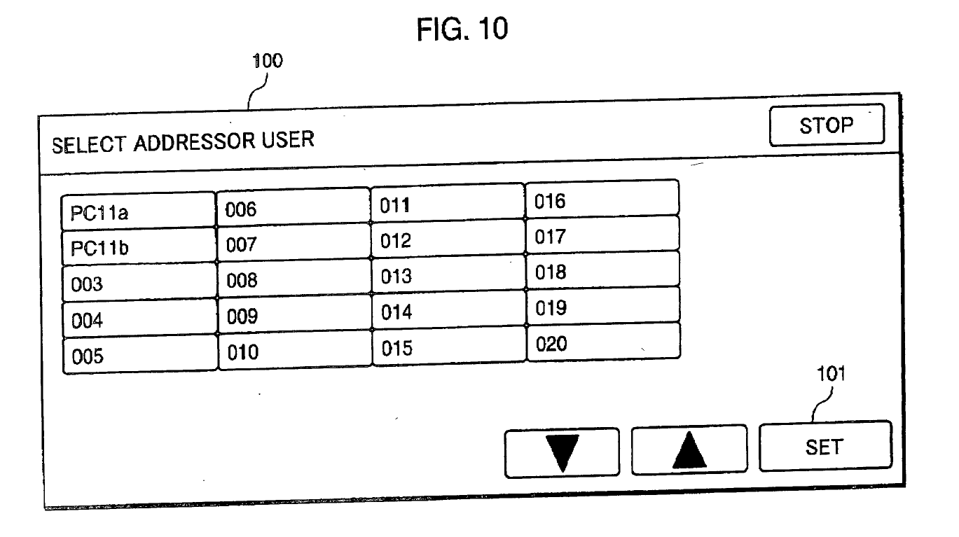

If E-MAIL TRANSMISSION 52 is selected, a addressor (user) selection screen 100 as shown in FIG. 10, is displayed. At that time, the registered data displayed as addressor is read out from the addressor memory 23a by way of the addressor selection control 24.

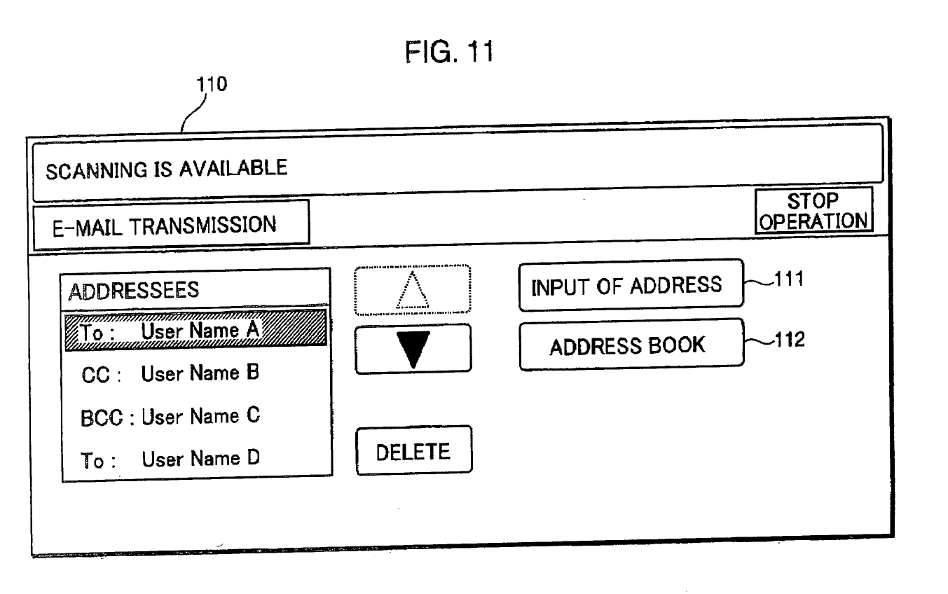

If PC11a is select to select setting 101 on the addressor (user) selection screen 100 shown in FIG. 10, then E-mail addressee selection screen 110 as shown in FIG. 11 is displayed. With the E-mail addressee selection screen 110, the user may select either INPUT OF ADDRESS 111 for inputting E-mail address of the addressee or ADDRESS BOOK 112 for selecting an addressee from the data registered at memory 23.

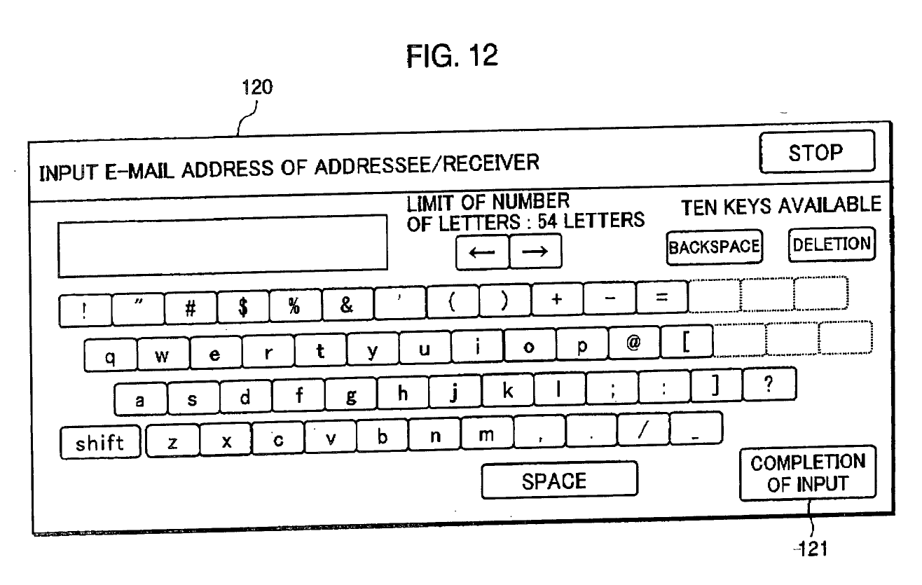

If INPUT OF ADDRESS 111 is selected, an E-mail address input screen 120 as shown in FIG. 12 is displayed. Then, the user may input a desired E-mail address and operate COMPLETION OF INPUT 121 to complete input operation.

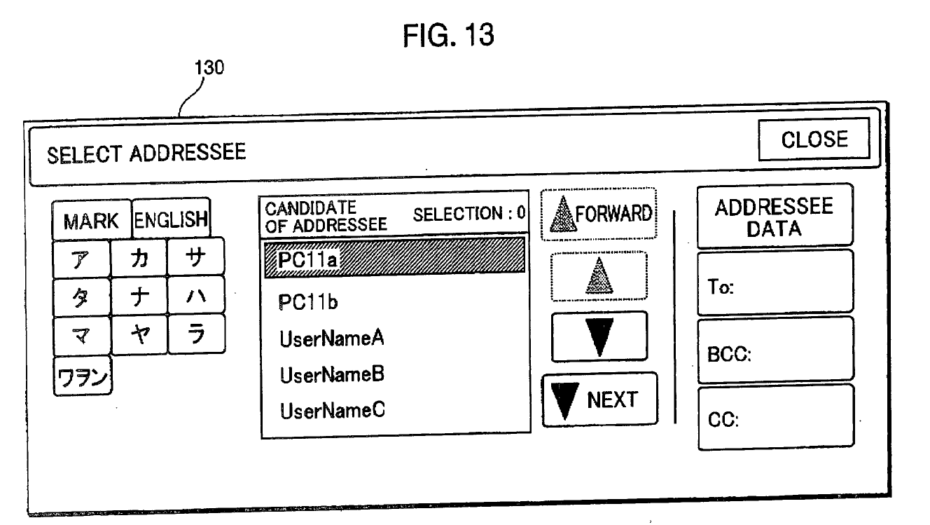

If ADDRESS BOOK 112 is selected, a transmission selection screen as shown in FIG. 13 is displayed. At this time, the registered data displayed as candidates of addressees are read out from the registered data in the addressor memory 23a as well as from the E-mail address book in the addressee data memory 23 by means of the addressee selection control 25.

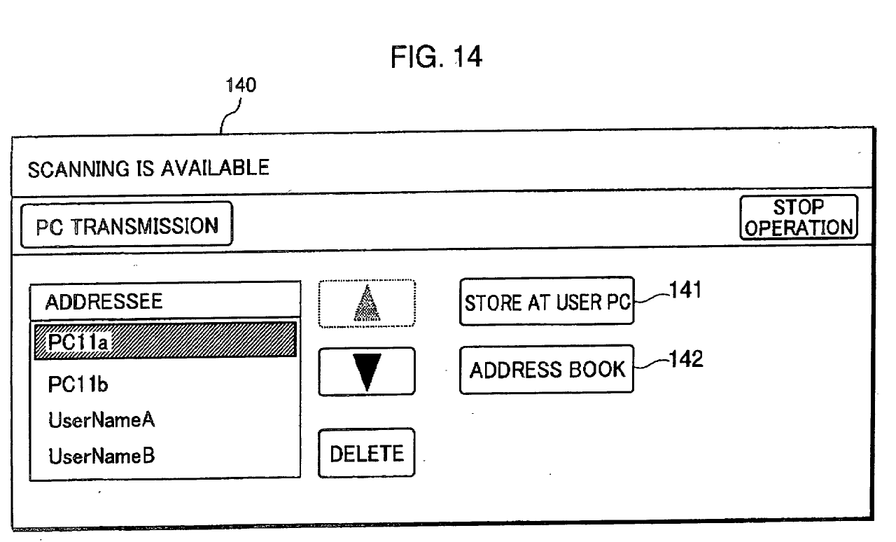

If PC TRANSMISSION 53 is selected on the scanner function selecting screen 50 shown in FIG. 5, a addressor (user) selection screen 100 as shown in FIG. 10 is displayed as in the case of the addressor selection at the time of E-mail transmission described above. Then, if an addressor is selected, a PC addressee selection screen 140 as shown in FIG. 14 is displayed. With this PC addressee selection screen 140, the user may select either STORE AT USER PC 141 for storing the data at the User's personal computer, i.e. storing at the selected addressor, or ADDRESS BOOK 142 for selecting an addressee from the registered data in the memory 23.

If STORE AT USER PC 141 is selected, the image data may be transmitted to the personal computer selected as the addressor.

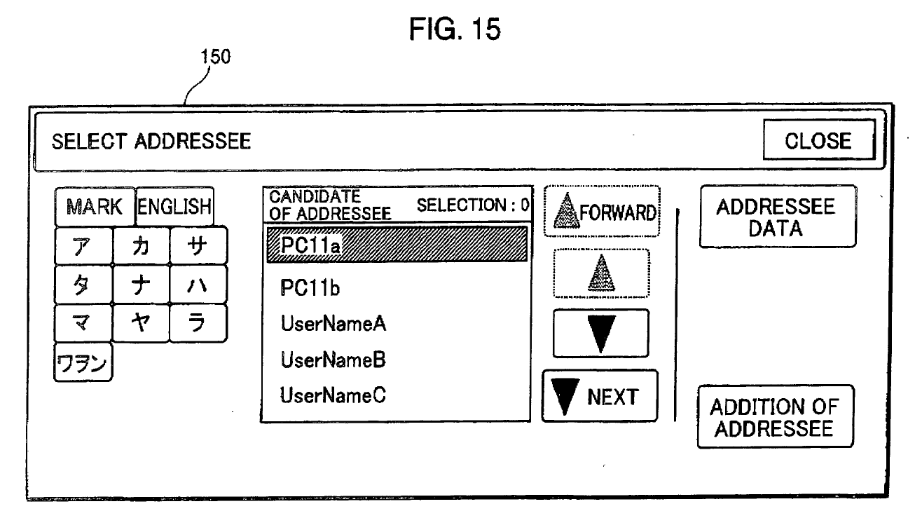

If ADDRESS BOOK 142 is selected, an addressee selection screen 150 as shown in FIG. 15 is displayed. At this time, the registered data displayed as candidates of addressees are read out from the PC transmission address book in the addressee data memory 23b as well as from the registered data in the addressor data memory 23a, by means of addressor selection control 25.

Thus, according to the embodiment as described above, addressors and addressees are separately registered in the registering operation, but not only the data registered as addressees but the data registered as addressors are output for the selection of one or more addressees to enable the use to select a addressee from the data registered as addressors as well as data registered as addressees. Accordingly, it is unnecessary for the user to register the ID data twice in the addressor and addressee memory regions, thereby save the time of the registration

As another embodiment, the network scanner may be arranged such that ID data are registered in a single memory without differentiating the ID data to data of addressor and addressee, and all the stored data are output as candidates of addressors or addressees. With this system, double registration is avoided and save the time of registering operation.

The embodiment is described in the above with reference to a network scanner as a communication device, the present invention is applicable to another communication device such as a network facsimile.

According to the present invention, a selection control outputs all the data stored at a memory or memories for the display of candidates of addressors or addressees. In other words, all the address ID data are displayed whether they are registered as the data for addressors or the data for addressees. Then, the user may not register the same ID data twice in addressor memory region and addressee memory region, thereby saving the time and work for the registration.

According to another aspect of the present invention, data for addressors and the data for addressees are stored separately and the selection control outputs both of the data stored for addressors and the data stored for addressees, so that the uses may select the data for the addressors for the setting of an addressee and the user may not register the same ID data twice in addressor memory region and addressee memory region, thereby saving the time and work for the registration.

According to yet another aspect of the present invention, the selection control is arranged to output only the data registered for addressors as candidates of addressors, the user may easily select a desired addressor from a limited number of candidates.

According to further aspect of the present invention, the selection control is arranged to output only the data of addressors and addressees including their E-mail addresses as candidates of addressees to be accessed through E-mail, so that the user will not mistakenly send E-mail to an addressee to whom access can not be made through E-mail.

According to still further aspect of the present invention, the selection control is arranged to output only the data of addressors and addressees including their PC addresses as candidates of addressees to be accessed to a personal computer, so that the user will not mistakenly send data to an addressee for whom PC address has not been registered.

This application is based on Japanese patent application No. 2001-865903 filed on Nov. 30, 2001, the contents of which are hereby incorporated by references.

As the present invention may be embodied in several form without departing from the spirit of essential characteristics thereof, the present embodiments are therefore illustrative and not restrictive, since the scope of the invention is defined by the appended claims rather than by the description preceding them, and all changes that fall within meets and bounds of the claims, or equivalence of such meets and bounds are therefore intended to embraced by the claims.

What is claimed is:

1. A communication device comprising a memory for storing data registered for addressors and addressees; and a selection control for output all the data stored in the memory as candidates of addressees.

2. A communication device as claimed in claim 1, wherein the memory includes a first memory for storing data registered as addressors, and a second memory for storing data registered as addressees, and the selection control is arranged to output both the data stored in the first and second memories as candidates of addressees.

3. A communication device as claimed in claim 2, wherein the selection control is arranged to output only the data stored in the first memory as candidates of addressors.

4. A communication device as claimed in claim 3, wherein the selection control is arranged to output only the data of addressors and addressees for whom E-mail address has been registered, when the communication device is set to send data through E-mail.

5. A communication device as claimed in claim 3, wherein the selection control is arranged to output only the data of addressors and addressees for whom a personal computer address has been registered, when the communication device is set to send data to a personal computer.

6. A communication device as claimed in claim 1 wherein the communication device is a network scanner or network facsimile.
